(19) United States
(12) Patent Application Publication
(10) Pub. No.: US 2014/0211018 A1
(43) Pub. Date: Jul. 31, 2014

(54) DEVICE CONFIGURATION WITH MACHINE-READABLE IDENTIFIERS

(71) Applicant: HEWLETT-PACKARD DEVELOPMENT COMPANY, L.P., (US)

(72) Inventors: Diogo Strube de Lima, Porto Alegre (BR); Roberto Bender, Porto Alegre (BR); Rodrigo Menezes do Prado, Porto Alegre (BR); Otavio Correa Cordeiro, Porto Alegre (BR); Soma Sundaram Santhiveeran, Cupertion, CA (US)

(73) Assignee: HEWLETT-PACKARD DEVELOPMENT COMPANY, L.P., Houston, TX (US)

(21) Appl. No.: 13/753,403

(22) Filed: Jan. 29, 2013

(51) Int. Cl. H04N 7/18

(52) U.S. Cl. CPC H04N 7/181
USPC 348/159

(57) ABSTRACT

An example in accordance with the present disclosure includes receiving, from a node, information associated with a machine-readable identifier; accessing a profile associated with the machine-readable identifier from the storage medium; and configuring a device associated with the node based on the profile.

### BACKGROUND

Systems such as those for video surveillance, audience analytics and interactive digital signage often employ imaging devices, such as digital cameras, to facilitate their operation and image/data gathering. Advances in imaging device technology have improved the versatility and image quality of such systems.

### BRIEF DESCRIPTION OF THE DRAWINGS

For a more complete understanding of examples described herein, reference is now made to the following descriptions taken in connection with the accompanying drawings in which:

FIG. 1 is a schematic view of a system according to an example;

FIG. 2 is a plan view of a system according to an example;

FIG. 3 is a schematic illustration of an imaging device reading a machine-readable identifier according to an example;

FIG. 4 is a schematic view of an imaging device reading a machine-readable identifier according to another example;

FIG. 5 is a flowchart illustrating a process according to an example; and

FIG. 6 is a schematic representation of an example device in accordance with an example.

### DETAILED DESCRIPTION OF THE DRAWINGS

In various examples described below, devices in a system, such as video cameras in a surveillance system, may be configured through the use of machine-readable identifiers, such as barcodes or quick response (QR) codes. An image of a machine-readable identifier may be transmitted to a controller, which may use information associated with the identifier to access a stored profile. The device may thus be configured using the stored profile associated with the identifier read by the device to be configured.

As discussed above, various types of systems employ imaging devices, such as cameras, to gather data and receive inputs. Applications for such systems may include surveillance, audience analytics, digital signage, and numerous others. Such systems may be network-based and may employ a processor-controlled framework or operational structure to connect system components, direct system communications and manage various system operations, including by remote control. Imaging devices may be deployed as part of, and throughout, such systems to scan and gather information and data from respective fields or scopes of view. For example, a remote control surveillance system may utilize several cameras deployed at various locations of a building, structure or property, for real-time observation and recording of activity. In other examples, systems may utilize imaging devices such as cameras in combination with digital signage to observe viewer behavior, which may be quantified by application of algorithms and quantitative measurement tools to the observed images to generate detailed data about the effectiveness of a particular sign or advertisement, for example.

Such systems including multiple camera locations, for example, may be deployed and controlled from one or more central operating centers. In this regard, deployment of multiple centrally controlled and monitored cameras may provide for efficient central and remote monitoring and surveillance of large areas, thus enhancing security.

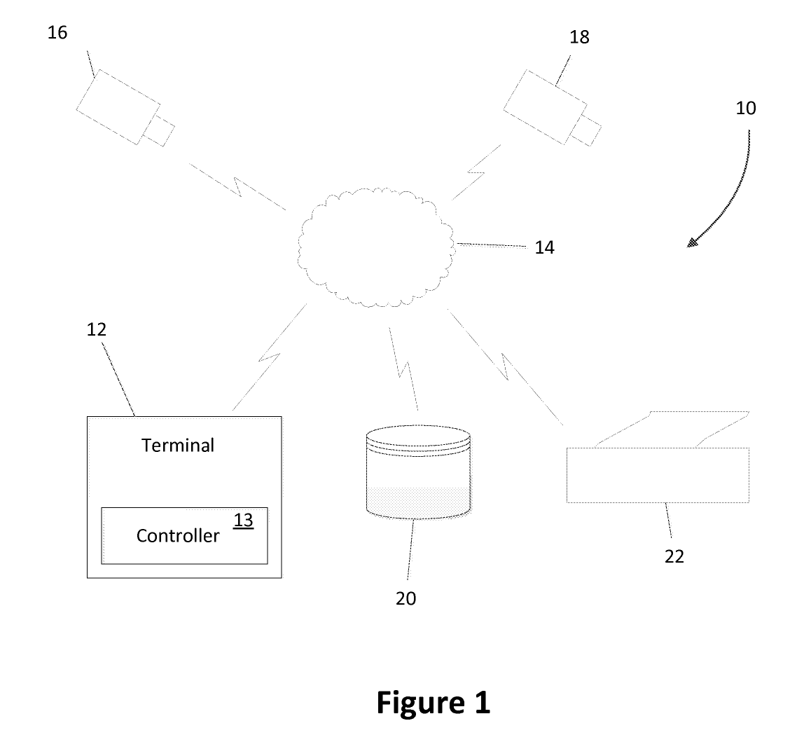

Various examples described herein may be directed to configuration of imaging devices by leveraging the capabilities of such imaging devices to view and read visual tags configured to convey configuration information, thus facilitating set-up. Referring now to FIG. 1, there is illustrated a schematic representation of the various components and interconnections that may constitute an example system. The example system 10 may include a terminal 12, which may be any computing or communication device, or any other type of device with a user interface, such as a remote terminal, mobile or otherwise, that may allow a user to monitor or control the system 10 and various individual components of the system 10. As illustrated in the example of FIG. 1, the terminal 12 may have a controller 13 (e.g., a processor) which facilitates operation of the terminal, including communication with various other components. In various examples, such devices may include desktops, laptops, mobile telephones or tablet devices. The terminal 12 may be in communication with other components of the system 10, directly or indirectly, through various combinations of wired and wireless communication links, for example. In an example, a wired or wireless network 14 may provide for communication and interoperability between various components of the system 10. In various examples, the system 10 may also include any number of imaging devices. In the example system 10 depicted in FIG. 1, the imaging devices may include cameras 16, 18. As will be discussed in greater detail below, the cameras 16, 18 may feature capabilities that facilitate viewing of machine-readable identifiers, as well as the accessing of respective associated information or the execution of associated instructions.

In an example, the system 10 may further include a storage medium 20. The storage medium 20 may be used to store data such as operational, communication and control framework information associated with various components of the system 10. The stored data may include, for example, configuration information for the system 10 and individual system components, as well as input that may be observed or read by the cameras 16, 18. In various examples, the storage medium 20 may include a database, a flash drive, a CDROM, or any other non-transitory, machine-readable, data storage device. In an example, the system 10 may include a printer 22. In various examples, the printer 22 may be utilized in facilitating operation of the system 10 in particular examples, as will be described in greater detail below.

Referring again to FIG. 1, in setting up a system 10, the cameras 16, 18 may be located at particular areas or zones of interest. For example, in connection with a facility security system, the cameras 16, 18 may be installed and mounted in areas, or zones, where surveillance is desired, such as in particular rooms of a facility, entrances, exits, etc. As mentioned above, installation and setup of the cameras 16, 18 may be a manual, labor-intensive and time-consuming task. The cameras 16, 18 may be physically mounted to provide for an effective scope of field of vision, and they may be communicatively connected to the operational framework or network of the system through direct physical connection, wirelessly, or through other appropriate connection infrastructure. In addition, their settings may be configured appropriately for conditions in the respective desired zones or fields of view, as will be discussed in greater detail below. For example, settings such as contrast, exposure, gain, white balance, and brightness, among others, may be set so to provide useful images in the particular conditions in the zone of interest. In addition, the focus of the cameras 16, 18 may be set, and each camera 16, 18 may be connected to the system framework in a way that provides for its unique identification. The unique identification of each imaging device in the system 10 may facilitate a user's control of the imaging device, as well as further adjustment of the device's settings, including orientation as to the field of view of the uniquely-identified imaging device, for example.

As mentioned above, machine-readable identifiers may facilitate the access or utilization of information that is directly encoded in the machine-readable identifier, or stored elsewhere. Briefly, an imaging device, or another device or system that incorporates an imaging device, can read or view a machine-readable identifier that is displayed to the imaging device. Upon reading or viewing the identifier, an automatic process may be launched to cause a predetermined action to occur, or certain data to be retrieved or accessed. For example, consider a computing device or mobile phone configured to receive input through an imaging device. A machine-readable identifier, such as a quick-response (QR) code, barcode (e.g., 1-dimensional or 2-dimensional barcode), or some other type of visual tag, may be brought into the field of view of the imaging device. The information encoded onto the machine-readable identifier may include instructions for triggering an action, such as causing the web browser of the computing device to be directed to a particular URL. Alternately, a complete set of data or executable instructions may be stored on a machine-readable identifier, for viewing and input into a computing device or storage medium through an imaging device. In addition, displaying a machine-readable identifier to an imaging device may cause data stored on a computing device, mobile phone, or other accessible storage or memory to be accessed. Such storage may be part of the computing device, mobile telephone, tablet, etc., or it may be external storage accessible through direct connection or through a network that may be wired or wireless. If such data constitutes executable instructions, the instructions may be automatically executed upon display of the machine-readable identifier to the imaging device. A machine-readable identifier may also provide or trigger access to supplemental data that may augment, enhance or enrich other information or images being viewed or read by the imaging device. It is to be appreciated that any type of machine-readable identifier may be configured for use with examples described in this application, and nothing in this application is to be understood as limiting the type of machine-readable identifier that may be utilized or appropriate.

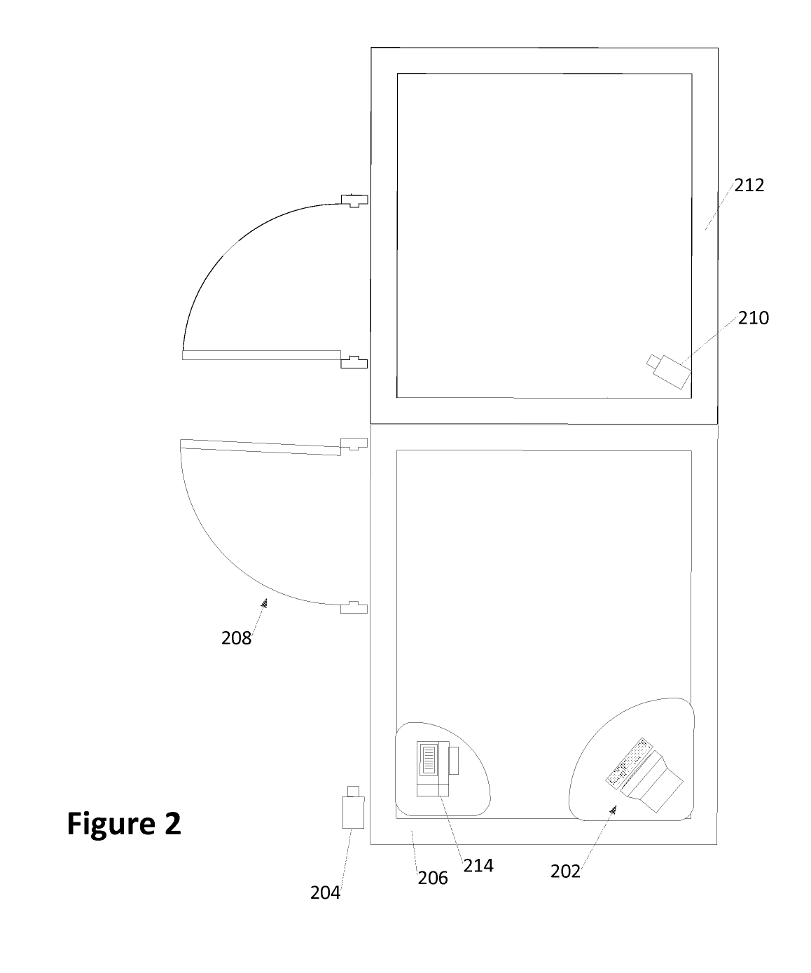

In an example, a machine-readable identifier may be generated in connection with configuring the imaging devices that are used with a surveillance system. The imaging devices may be cameras or other types of imaging devices that have the capacity to view visual images. Referring now to FIG. 2, there is illustrated a plan view of various components of a system which may be installed in a multi-room structure. A user may input configuration and settings information corresponding to nodes (not pictured) through a terminal 202, at the time of designing such a system, when the system is actually being installed, or after installation. As used herein and in various examples, a “node” may correspond to a location or a placeholder for an imaging device, such as a camera. In various examples, a node may be an access point at which a device, such as a camera, may be coupled or installed.

The configuration information corresponding to each node may include settings and other information useful and appropriate for configuring an imaging device that is or will be located in a particular location. The system may allow for the configuration and specification of settings information associated with any number of such nodes. A respective imaging device may be positioned to correspond to each node, and the profile associated with each node may include the respective settings and configuration information. For example, configuration information corresponding to a node is stored or encoded in a profile that is associated with a camera 204, which is connected to this node. As illustrated in FIG. 2, the camera 204 may be positioned in a location with specific camera settings and configurations, e.g., outside of the room 206, with a view of a doorway 208. Camera settings such as exposure, gain, white balance, brightness and contrast, among others, may be set for the anticipated or actual conditions affecting the field of view of the camera 204. At the terminal 202, a user may input or be queried for particular configuration information corresponding to the node corresponding to the camera 204 and stored or encoded in an associated profile. The camera 204 may be connected to such a node. User input may be facilitated by any manner of input queries, user-configurable inputs, user interfaces, or combinations thereof, which facilitate the input and configuration process for such a system. As illustrated in the example of FIG. 2, an additional camera 210 may be located in room 212. As discussed in connection with the camera 204, a user may utilize the terminal 202 to input and store or encode settings and configuration information corresponding to a node, in a profile associated with the node, and the camera 210 may be connected to this node. Of course, such a system is not limited to any particular number of nodes, but can administer the creation of profiles containing configuration information for any number of corresponding nodes, to which imaging devices may be connected.

Any type or manner of appropriate device (e.g., desktop or laptop computer, network-connected terminal, tablet device, mobile phone, etc.) may be utilized by a user for entry of settings and configuration information corresponding to respective nodes in a system. Furthermore, all of the components of such a system may be communicatively connected via networks, or by direct physical connections through any combination of wired or wireless connections. In addition to settings described above, each profile may include any other type of settings and configuration information corresponding to nodes to which imaging device are connected, such as focus, field of view, and camera orientation (e.g., for cameras including remote control orientation capabilities such as elevation, sweep, etc.), among other configuration-related information. Further, in various examples, the profile may include a description of each device (e.g., “CAMERA IN DATACENTER ON 3RD FLOOR”), an address of a server to which it connects, authentication credentials for authenticating the device and/or the server, and other such information. Moreover, the profile may include an identifier for the particular node and respective connected imaging device, for a user's ease of identification and control of the particular node and associated imaging device. The identifier may thus facilitate a user's adjustment or configuration of new settings information for a particular node after an initial installation and setup. That is, an identifier (e.g., a unique identifier) makes it easy to find a profile associated with a particular node when stored profiles are indexed according to corresponding unique identifiers. In addition to the automated configuration of imaging devices, system such as those described above, for example, may also provide for manual configuration of imaging devices through remote control facilitated by the terminal 202, network connections, and interoperability of imaging devices (e.g., cameras 204, 210) within the system.

The respective configuration information input as profiles corresponding to any or all nodes in such systems may be stored in a storage medium (not shown in FIG. 2), whether input through a user interface at the terminal 202, directly and manually input at the imaging device, or through other input modes. Thus, in addition to the storage of initial configuration information corresponding to a particular node, updated and modified settings may be stored within the original profile or an updated profile corresponding to the particular node. The storage medium may be part of the terminal 202 or other input device, or the storage medium may be a remote stand-alone or cloud-based storage medium. A storage medium may facilitate the storage of profiles containing configuration information corresponding to particular nodes. The profiles may be exported and a respective unique machine-readable identifier corresponding to each node may be generated and associated with each respective profile.

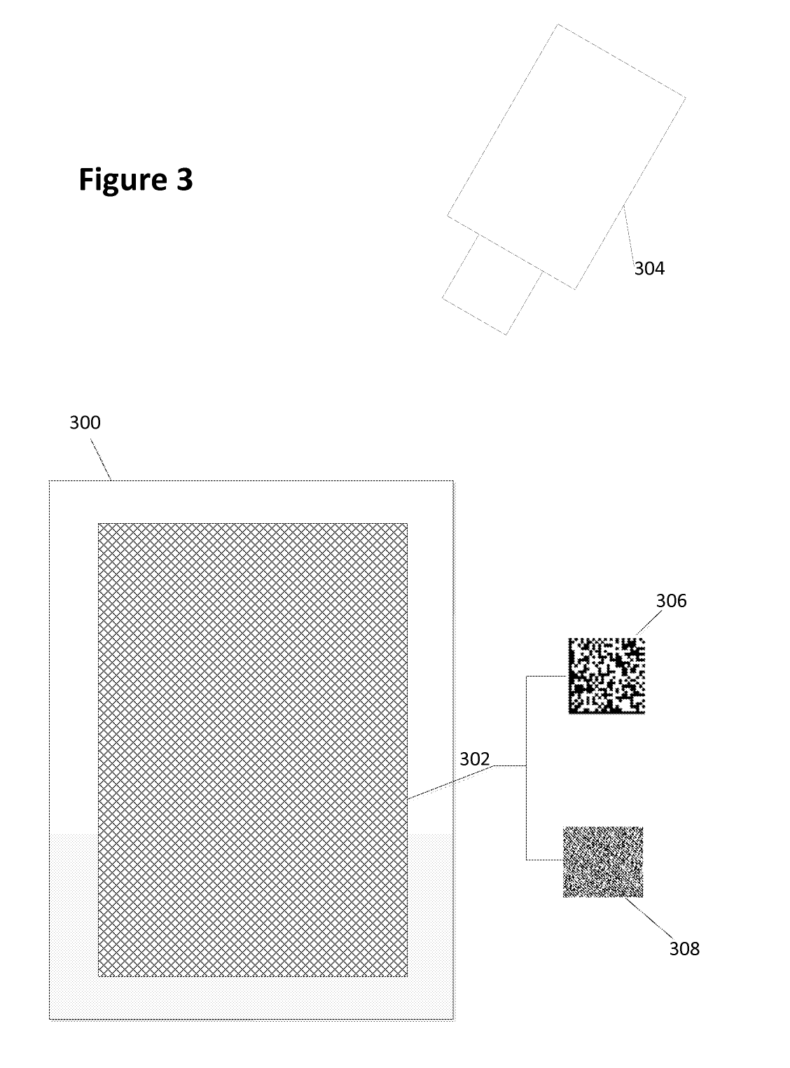

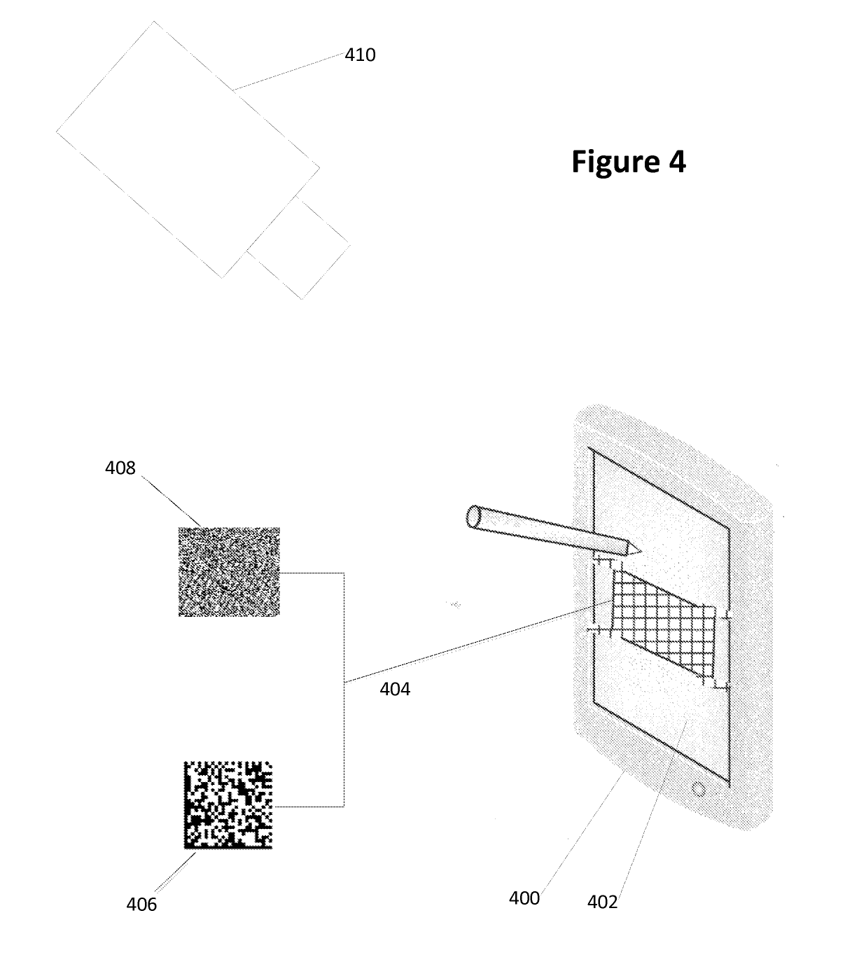

Machine-readable identifiers may be configured in various forms for display to imaging devices. For example, once generated, QR codes, barcodes, or Aurasmas, among others, may be printed on a print medium, such as a sheet of paper, for example, utilizing a printer 214. Referring now to FIG. 3, there is illustrated an example physical medium 300 (e.g., a sheet of paper) on which a machine-readable identifier 302 is printed. The machine-readable identifier may be in the form of a 1-dimensional or a 2-dimensional barcode 306, a QR code 308 or any other form of machine-readable identifier. As illustrated in the example of FIG. 3, the machine-readable identifier 302 may thus be displayable for view or reading by an imaging device 304, such as a camera (e.g., digital video camera). In another example, images of such machine-readable identifiers may also be transmitted to devices such as laptop computers, smartphones or tablet devices, or any other device having a display screen configured to display such images to imaging devices. Machine-readable identifiers may be transferred to such devices with display screens through networks, transportable storage mediums, wireless communications, or any other available means for transferring data to such devices. In other examples, machine-readable identifiers may be generated directly on such devices. For example, in FIG. 4, there is illustrated a tablet device 400 with a display screen 402 on which a machine-readable identifier 404 is displayed. Again, the machine-readable identifier may be in the form of a 1-dimensional or 2-dimensional barcode 406, a QR code 408, or any other form of machine-readable identifier. As shown in FIG. 4, the machine-readable identifier 404 may be displayable for view or reading by an imaging device 410.

Referring again to FIG. 2, there is illustrated an example wherein the cameras 204, 210 may be configured, and machine-readable identifiers corresponding to respective profiles may be generated by a user, utilizing terminal 202. The profile may be exported and associated machine-readable identifiers may be printed at printer 214, or transmitted to a device with a display screen. When cameras 204, 210 are deployed, including when they are replaced following their initial installation, a machine-readable identifier associated with a profile corresponding to the node to which cameras 204, 210 may be connected, may be displayed to the respective camera 204, 210. As noted above, the node may be a placeholder for a device, such as a camera, or an access point for the device.

As discussed above, the print medium on which the machine-readable identifier is printed may be directly displayed to a camera 204, 210, or the display screen of such a device may be displayed to camera 204, 210. Upon viewing a machine-readable identifier, the configuration information corresponding to a respective node may be accessed, and the system may facilitate automatic configuration and adjustment of a respective camera 204, 210 through the configuration information encoded in the machine-readable identifier or stored on the storage medium. As discussed above, cameras 204, 210 may thus automatically adjust to the various configuration and settings such as focus, exposure, gain, white balance, brightness, contrast, elevation, sweep, zoom level, region of interest, device description, server address, authentication credentials, etc., stored as a profile on the storage medium or encoded as a profile on the machine-readable identifier. In addition, display of the machine-readable identifier to an imaging device may similarly result in or trigger the display of text information to guide the user or technician in performing the configuration. This information may be transmitted or displayed to the user or technician on a computer, mobile phone, tablet or other such device.

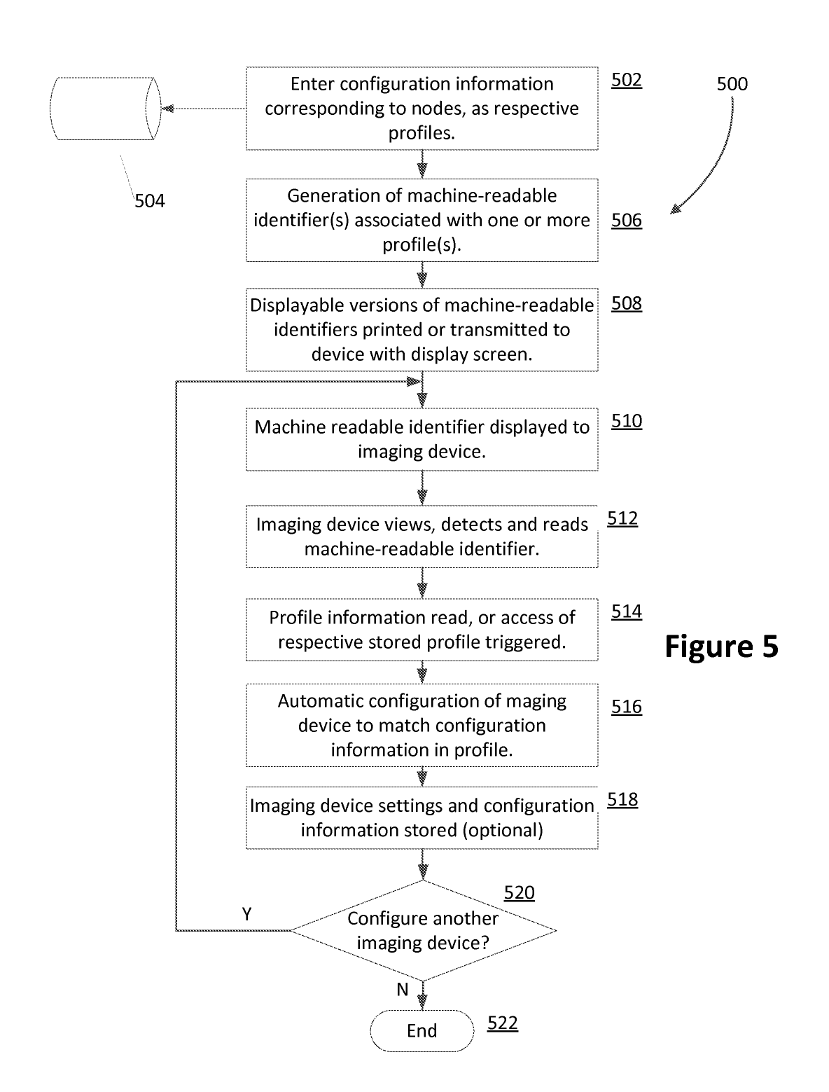

Referring now to FIG. 5, there is illustrated an example process 500 for configuration of an imaging device through the use of machine-readable identifiers. At box 502, configuration information, which may include settings, corresponding to one or more nodes is entered as one or more respective profiles. In an example, as discussed above, configuration information may be entered through a user interface at a terminal or other computing device. In another example, such configuration information may be input from a storage device, or retrieved from another device or from storage through a network. Configuration information corresponding to a particular node may be stored as a respective profile in storage medium 504. At box 506, profiles may be exported and machine-readable identifiers corresponding to the respective profiles may be generated. In another example, all of the configuration information of the respective profile may be encoded in the machine-readable identifier. At box 508, displayable versions of machine-readable identifiers may be printed on a print medium, or transmitted to a device with a display screen. Machine-readable identifiers may be displayed to an imaging device connected to a node associated with a respective profile, at box 510. In an example, the precise physical location at which the machine-readable identifier is displayed to the imaging device may be the desired focal point of the imaging device, and the imaging device will automatically be so configured. The imaging device may view, detect and read the machine-readable identifier at box 512. The information displayed on the image of the machine-readable identifier may be read as a complete profile encoded on the machine-readable identifier, or the information displayed may trigger access of a profile stored on the storage medium as seen at box 514. Upon accessing the profile, the settings of the imaging device may be automatically configured to match those in the profile, as seen at box 516. Settings and configurations of the imaging device, including driver options such as camera brightness and contrast, among other items, may thus be set. In another example of configuring an imaging device, the focus of a camera may be calibrated, comparing camera images with different focus values and selecting the one with the best degree of visualization of the machine-readable identifier. At box 518, information for a respective imaging device may be stored, such as a description, unique identifier, and location. If other imaging devices are to be configured (box 520), the process returns to box 510 for configuration of the next imaging device. When configuration is completed for all imaging devices desired to be configured, the process may be exited at end button 522.

It is to be understood that the various examples may be implemented individually, or collectively, in systems and apparatus comprised of various hardware and/or software modules and components, including middleware. Such systems and apparatus may, for example, comprise a processor, a memory unit, and an interface that are communicatively connected to each other, and may range from desktop, server and/or laptop computers, to consumer electronic devices such as mobile devices and the like. Such systems, apparatus and component devices may include input and peripheral devices, and other components that enable the system or apparatus to read and receive data and instructions from various media, input devices, a network, or other inputting means in accordance with the various examples of the disclosure. It should be understood, however, that the scope of the present disclosure is not intended to be limited to one particular type of system, apparatus, or configuration of devices.

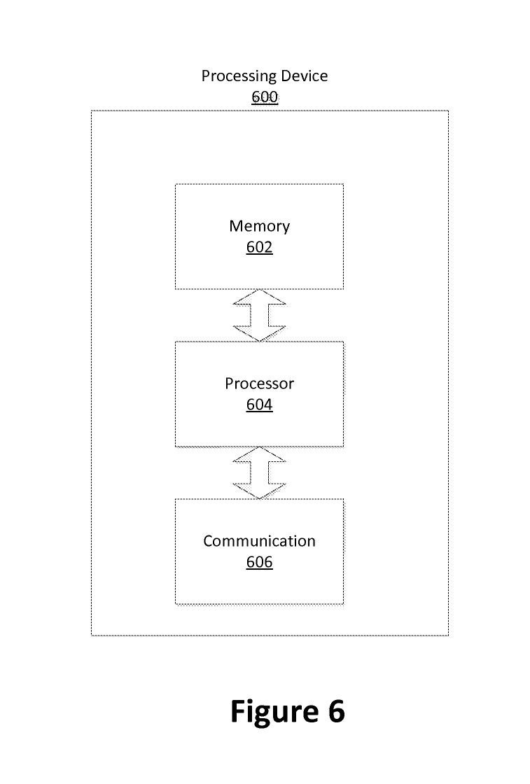

As an example, FIG. 6 illustrates a block diagram of an example device 600 within which various examples may be implemented. In one example, the device 600 may include the system 10 of FIG. 1, or components thereof. The device 600 comprises at least one processor 604 and/or controller, at least one memory unit 602 that is in communication with the processor, and at least one communication unit 606 that enables the exchange of data and information, directly or indirectly, with a communication medium, such as the Internet, or other networks, entities and devices. The processor 604 can execute program code that is, for example, stored in the memory 602. The memory 602 may also include the storage mediums described above, such as the storage medium 20, of FIG. 1, for example. The communication unit 606 may provide wired and/or wireless communication capabilities in accordance with one or more communication protocols and interfaces, and therefore it may comprise the proper transmitter/receiver antennas, circuitry and ports, as well as the encoding/decoding capabilities that may be necessary for proper transmission and/or reception of data and other information.

Similarly, the various components, or sub-components and devices described and contemplated may be implemented in software, hardware, firmware, and/or middleware. The connectivity between respective processors or other component modules and/or sub-components within the processors or other component modules may be provided using any one of the connectivity methods and media that is known in the art, including, but not limited to, communications over the Internet, wired, or wireless networks using the appropriate protocols.

Various examples described herein are described in the general context of method steps or processes, which may be implemented, in one example, by a computer program product or module, embodied in a computer-readable memory, including computer-executable instructions, such as program code, and executed by apparatus such as computers or computing systems in networked environments. A computer-readable memory may include removable and non-removable storage devices including, but not limited to, Read Only Memory (ROM), Random Access Memory (RAM), compact discs (CDs), digital versatile discs (DVD), etc. As such, the various disclosed examples can be implemented by computer code embodied on non-transitory computer readable media. In other examples, processes may be employed to perform operations on data, wherein the instructions for process operations and the data, or elements thereof, may reside on or be transferred through one or more computing devices or systems.

The foregoing description of examples has been presented for purposes of illustration and description. The foregoing description is not intended to be exhaustive or to limit examples of the present disclosure to the precise form disclosed, and modifications and variations are possible in light of the above teachings or may be acquired from the practice of various examples. The examples discussed herein were chosen and described in order to explain the principles and the nature of various examples and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

What is claimed is:

1. A system comprising:
a controller to communicate with one or more nodes; and
a storage medium having one or more profiles stored thereon, each profile being associated with a machine-readable identifier; and
wherein the controller:
receives, from a node, information associated with a machine-readable identifier;
accesses a profile associated with the machine-readable identifier from the storage medium; and
configures a device associated with the node based on the profile.

2. The system of claim 1, further comprising:
an imaging device coupled to each of the one or more nodes.

3. The system of claim 2, wherein the imaging device is a video camera.

4. The system of claim 1, wherein the device associated with the node is an imaging device.

5. The system of claim 1, wherein the profile includes at least one of the following: device drivers, focus instructions, calibration information, contrast information, exposure information, gain information, white balance information, brightness information, elevation information, sweep information, zoom level information, region of interest information, device description information, a server address, or authentication credentials.

6. The system of claim 1, wherein the machine-readable identifier comprises a printed image or a digital image displayed on a screen.

7. The system of claim 1, wherein the machine-readable identifier is a quick-response (QR) code or a bar code.

8. The system of claim 1, wherein the information is received through a network.

9. A method comprising:
receiving, from a node, information associated with a machine-readable identifier;
accessing a profile associated with the machine-readable identifier from the storage medium; and
configuring a device associated with the node based on the profile.

10. The method of claim 9, wherein the device associated with the node is an imaging device.

11. The method of claim 10, wherein the imaging device is a video camera.

12. The method of claim 9, wherein the profile includes at least one of the following: device drivers, focus instructions, calibration information, contrast information, exposure information, gain information, white balance information, brightness information, elevation information, sweep information, zoom level information, region of interest information, device description information, a server address, or authentication credentials.

13. The method of claim 9, wherein the machine-readable identifier comprises a printed image or a digital image displayed on a screen.

14. The method of claim 9, wherein the machine-readable identifier is a quick-response (QR) code or a bar code.

15. The method of claim 9, wherein the information is received through a network.

16. A computer program product, embodied on a non-transitory computer-readable medium, comprising:
computer code for detecting a machine-readable identifier using an imaging device;
computer code for accessing a profile associated with the machine-readable identifier; and
computer code for configuring the imaging device based on the profile.

17. The computer program product of claim 14, wherein the imaging device is a video camera.

18. The computer program product of claim 14, wherein the profile includes at least one of the following: device drivers, focus instructions, calibration information, contrast information, exposure information, gain information, white balance information, brightness information, elevation information, sweep information, zoom level information, region of interest information, device description information, a server address, or authentication credentials.

19. The computer program of claim 14, wherein the machine-readable identifier is a quick-response (QR) code or a bar code.

20. The computer program of claim 14, wherein the computer code for detecting the machine-readable identifier comprises:
computer code for receiving information associated with the machine-readable identifier through a network.
